(19) United States
(12) Patent Application Publication
(10) Pub. No.: US 2021/0206081 A1
(43) Pub. Date: Jul. 8, 2021

(54) MATERIAL DEVELOPMENT TOOL

(71) Applicant: HEWLETT-PACKARD DEVELOPMENT COMPANY, L.P., Spring, TX (US)

(72) Inventors: Michael G. MONROE, Corvallis, OR (US); Pavel KORNILOVICH, Corvallis, OR (US); Andrew QUEISSER, Corvallis, OR (US); Glenn HADDICK, San Diego, CA (US)

(73) Assignee: HEWLETT-PACKARD DEVELOPMENT COMPANY, L.P., Houston, TX (US)

(21) Appl. No.: 16/074,551

(22) PCT Filed: Mar. 14, 2017
(86) PCT No.: PCT/US2017/022263

§ 371 Date: Aug. 1, 2018

(51) Int. Cl. B29C 64/307; B29C 64/393; B29C 64/264

(52) U.S. Cl. CPC B29C 64/307; B33Y 40/10; B29C 64/264; B29C 64/393

(57) ABSTRACT

A material development tool includes a first plate and a second plate. The first plate has an indentation of a predetermined depth. The second plate having an opening for receiving build material when placed on the first plate and is removable from the first plate. A recoater is used to move and spread the build material within the indentation of the first plate.

### BACKGROUND

Three-dimensional (3D) printing is an additive manufacturing process that is quickly growing market share due to its swift prototyping and flexible manufacturing ability to deliver functional devices rapidly and cost effectively. It is highly valuable when designing products that a single 3D printing system can work with various types of materials to meet customer expectations.

### BRIEF DESCRIPTION OF THE DRAWINGS

The disclosure is better understood with reference to the following drawings. The elements of the drawings are not necessarily to scale relative to each other. Rather, emphasis has instead been placed upon clearly illustrating the claimed subject matter. Furthermore, like reference numerals designate corresponding similar parts through the several views. For brevity, some parts already described may not be re-described in later drawings.

FIG. 1A is a perspective drawing of one example of a material development tool with a spreading plate having an indentation;

FIG. 1B is a perspective drawing of the example material development tool of FIG. 1A with an example heat plate;

FIG. 1C is a perspective drawing of the example material development tool of FIG. 1A showing an example of the spreading of a proposed build material;

FIG. 1D is a perspective drawing of the example material development tool of FIG. 1A with an example camera and example low angle illumination system to measure density of the spread proposed build material;

FIG. 1E is an example result of a density measurement for the example material development tool of FIG. 1A using a grid of sub-sections;

FIG. 2 is a perspective drawing of an example first plate having a stair step indentation;

FIG. 3 is perspective drawing of an example auxiliary heat light source and temperature reading camera for the example material development tool of FIG. 1A;

FIG. 4 is a chart with an example temperature vs time profile of an example reptation of a proposed build material;

FIG. 5 is a perspective drawing with an example auxiliary third plate used with the example material development tool of FIG. 1A to make multi-layered spreading of proposed build material;

FIG. 6 is a perspective drawing with an example auxiliary ramp plate for use with the example material development tool of FIG. 1A to allow for changing the approach of a roller to the build material before spreading;

FIG. 7 is a perspective drawing an example material development tool incorporating several features;

FIG. 8 is a perspective drawing of another example material development tool such as in FIG. 7 but with additional example heat light source and temperature camera auxiliary items;

FIG. 9 is a perspective drawing of example spreading results for a good spreadable build material at different example depths of an indentation in a spreading plate;

FIG. 10 is a perspective drawing of example spreading results for a very poor spreadable build material at different example depths of an indentation in a spreading plate; and

FIG. 11 is a flowchart of an example set of instructions to characterize a build material.

### DETAILED DESCRIPTION

A 3D article made using a 3D additive manufacturing process may consist of spreading many hundreds or many thousands of finely spread powder layers of build material that are fused, sintered, or otherwise formed into solidified build material. The build material includes particulate material that may be fused with fusing agents and heat, or sintered with irradiation such as from a laser or other electromagnetic source. The uniformity of these layers can affect the properties of the final 3D article. The way in which a powdered build material ‘spreads’ during the 3D additive process may be dependent upon one or multiple properties of the build material used. Even when chemically equivalent, the properties of build materials vary widely depending on both the atomization method used and the 3D printer manufacturing process conditions such as temperature, layer depth, chemical binding or energy-absorbing agents used, fusing lighting, and material impurities just to name a few. To obtain more control over 3D additive manufacturing processes, service providers, or 3D printer manufacturers should be able to understand the properties and properly control the characteristics of build material used. Having a choice of different types of build material that are compatible with a given 3D printing system allows 3D printer manufacturers to have confidence that printed parts have a desired strength, aesthetic properties and other characteristics and that part designers may have more degrees of design freedom. However, it is difficult to know beforehand how a proposed build material will perform without considerable testing with the 3D printing equipment and processes.

The development of a new type of build material for use with a given 3D printing system may be complex, time consuming, and risky. The material development tool disclosed herein provides an apparatus and technique to speed up the process of developing, testing, and approving new types of build material for use with a given 3D printing system. It may do so by limiting the amount of material having to be produced for the testing process, and by examining the physical and thermodynamic properties of the material with, for example, visible, I/R, and other types camera systems. More detail is found in the following detailed description of the figures.

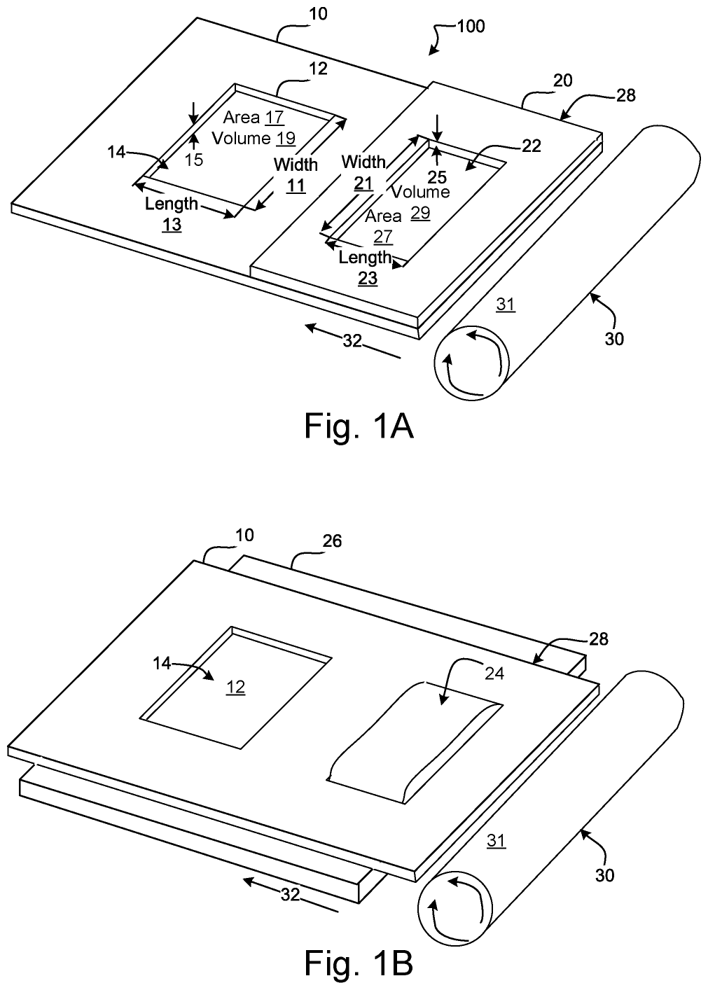

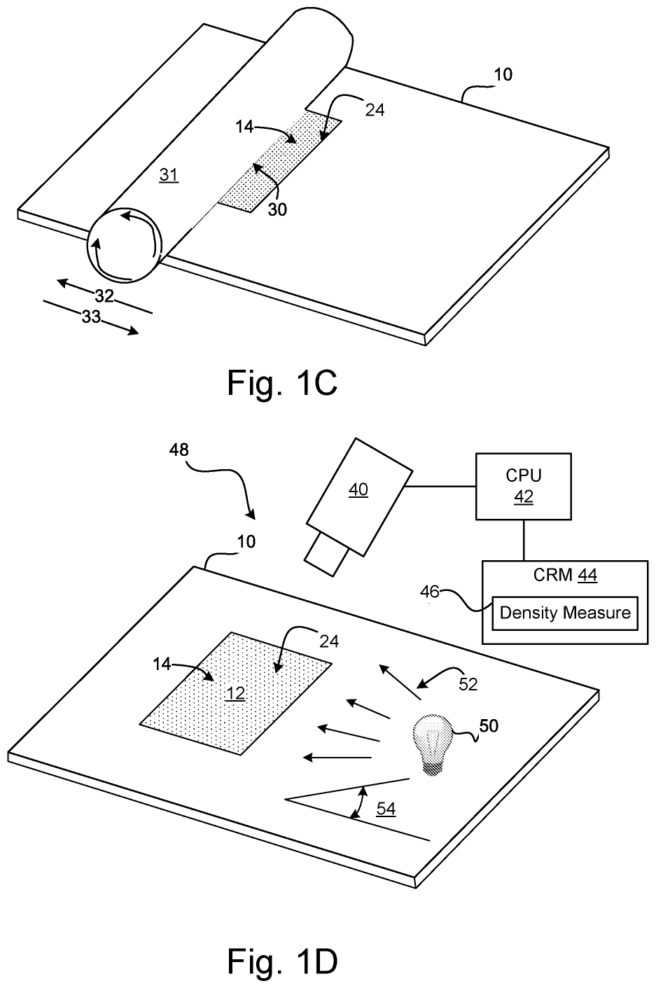

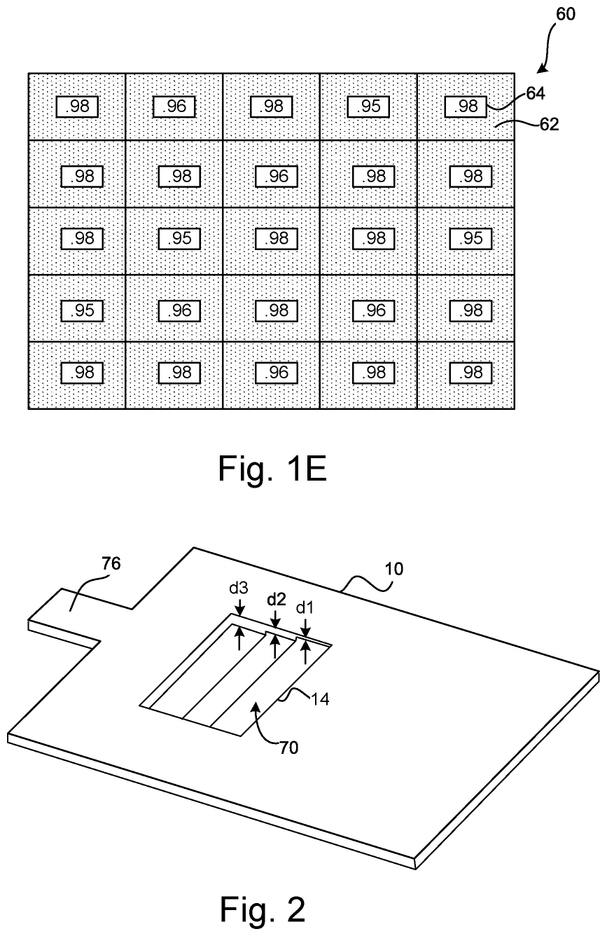

FIGS. 1A-1D are a set of perspective drawings of one example material development tool 100 as shown in FIG. 1A with a spreading or first plate 10 having an indentation section 12 with an indentation 14 of a predetermined height or depth 15. First plate 10 may be made of aluminum, stainless steel, iron, ceramic, or plastics as well as other materials. However, as will be described below for FIG. 1B, in one example the first plate 10 may be made of a thermally conductive material. The indentation 14 is of a small area 17 of a few square inches but able to be more or less, and of a fixed volume 19, such as between 50 and 100 cc (cubic centimeters) but able to be more or less, that is countersunk or formed into the first plate 10. The indentation 14 in this example is a rectangle of a width 11, a length 13 forming an area 17. The volume 19 is formed by the area 17 and a depth 15 of the indentation 14 into the first plate 10. In this example, the indentation 14 is of a rectangular shape but other shapes such as circular, barrel, triangular, hexagon, octagon, abstract, and the like may also be used for indentation section 12. However, a rectangular shape is most likely to emulate a production 3D printing tool. Further, in other examples there may be multiple indentations of various depths 15 in separate areas 17 or within multiple areas 17.

The material development tool 100 may be used to test the spreadability and fusibility properties of build materials 24 proposed to be used for a 3D printing process or production 3D printing tool. To allow for maximum and efficient investigation of suitable materials, the material development tool 100 may use a very small amount (i.e. 50 to 100 cc) of a proposed build material 24 that is first placed, accurately measured, and organized in a second plate 20 within an opening 22 before removing the second plate 20. The proposed build material 24 may then be spread over area 17 of indentation 14 in the spreading or first plate 10 using a recoater 30.

To reliably spread a build material 24 over several test cycles, the second plate 20 may be aligned and placed on top of the first plate 10 in a non-indented area 28 as shown in FIG. 1A. Second plate 20 may be made of the same or different material than the first plate 10. The second plate 20 may not be made of a thermally conducting material but can be thermally conducting in some instances. The second plate 20 may have an opening 22 with a width 21 about or slightly more than the width 11 of the first plate 10. The opening 22 may have a length 23 more, less, or equal to the length 13 of first plate 10. The opening 22 may also have an area 27 more, less, or equal to the area 17 of first plate 10 but typically will have an area 27 less than the area 17 of first plate 10. The opening has a depth 25 that extends from a top surface of the second plate 20 to a bottom surface of the second plate 20 and thus is the same as the thickness of the second plate 20. The depth 25 times the area 27 of the opening 22 creates a volume 29 of the opening 22. The volume 29 of the opening 22 may be substantially the same or slightly more than the volume 19 of the indentation 14 for build material 24 that will be placed in the opening 22 to fully fill the indentation 14 of the first plate 10 using the recoater 30. For ease of alignment, the second plate 20 may have a width substantially equal to the width of the first plate 10 and to align with at least one of the first plate 10 edges.

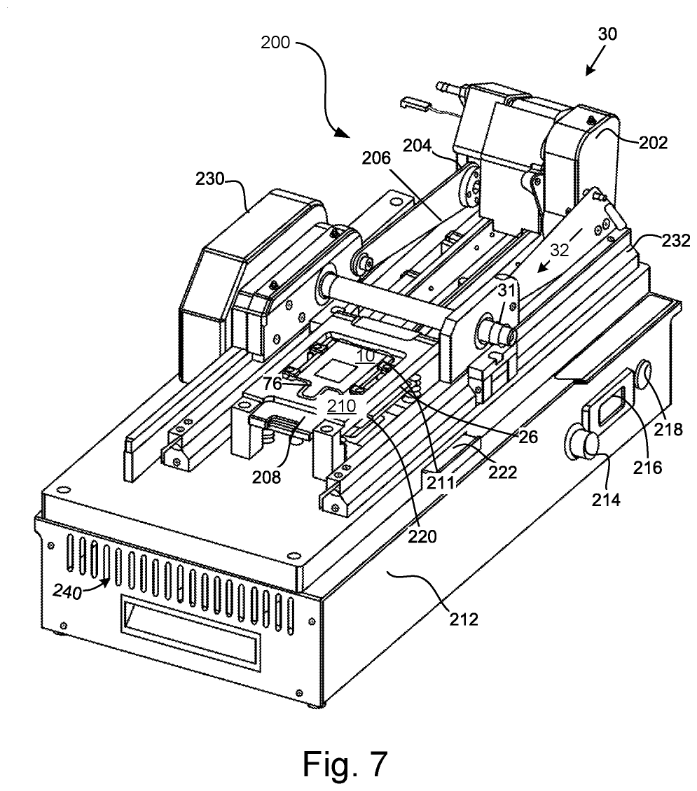

Recoater 30 may be a roller 31 in one example and a bar, a blade, or squeegee in other examples. When recoater 30 is a roller 31, the roller 31 may rotate in either direction for a test. For instance, the roller 31 may counter rotate the roller 31 in a direction 32 of travel or there may be some build materials 24 that may benefit with a follow rotating roller 31 that rotates in the direction 32 of travel. Before the recoater 30 is used to spread the build material 24 into the indentation 14, the second plate 20 is removed. Prior to the removal of the second plate 20 and after the proposed build material 24 is placed in the opening 22 of the second plate 20, any excess build material 24 may be removed by using a separate bar, blade, or squeegee to wipe any build material above the top surface of the second plate 20 off and away from the first plate 10 and the indentation 14, such as to a material recovery hopper (see waste hopper 220 and waste removal 222 in FIG. 7) disposed beneath the first plate 10.

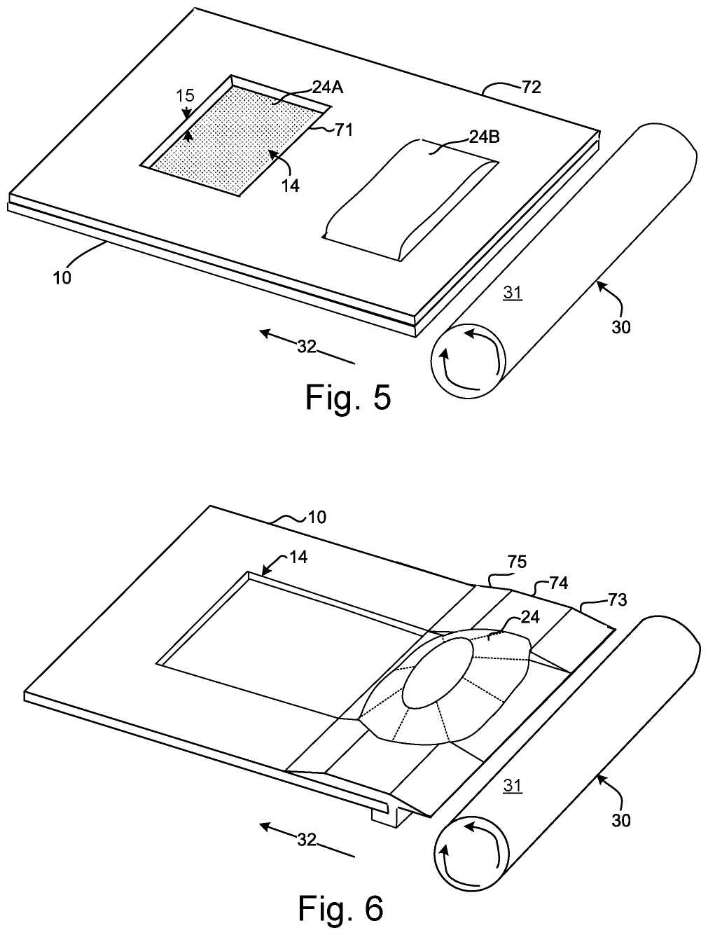

As shown in FIG. 1B, with an addition of a heat plate 26 disposed, placed, or otherwise positioned beneath the first plate 10, the spreading may be done between an ambient room temperature and an elevated temperature less than but near the melt temperature of the build material 24 to better simulate an actual manufacturing environment in a 3D printing tool. For instance, in a typical 3D printer, the working area or work bed of previous layers provides a heated surface for the next layer of build material 24 due to the fusing of previous layers. In this example, the second plate 20 is removed to leave a pile of proposed build material 24 on the top surface of first plate 10 organized to be moved into indentation 14. Other powder forming techniques may be used to place and form the volume of build material 24. The heat plate 26 may be adjusted to raise the temperature of the indentation 14, first plate 10, and the proposed build material 24 to an elevated temperature just below the melt temperature of build material 24 (see FIG. 4). In an alternative example, no heat plate may be used and an overhead heat source may provide for heating the build material 24. Also, in other examples, an overhead heat source may be used to heat the recoater 30 to simulate a rise in recoater 30 temperature in some 3D printing systems. Some potential build materials 24 may have a greater affinity to stick or otherwise bind to a recoater 30 when heated. Depending on the recoater 30 used and direction, such as a roller 31, the build material 24 may therefore bind and build up on the recoater 30. The recoater 30, a roller 31 in one example, is advanced in a direction 32 and counter-rotated with direction 32 to contact and drive the build material 24 into the indentation opening 12 of indentation 14.

FIG. 10 illustrates the advancement of the roller 31 of recoater 30 along direction 32 in which the build material 24 is spread into indentation 14 using a counter-rotating roller 31. Once the recoater 30 has completed spreading the build material 24 into indentation 14 it may be lifted and returned in an opposite direction 33 and away from the first plate 10 so that the spread of build material 24 formed in indentation 14 may be observed, either by the human eye or by one or several vision or camera systems using one or several wavelengths of electromagnetic radiation. In another example, roller 31 may be co-rotated with direction 32. Additionally, in some examples, the spreading may be performed by first spreading toward a direction 32 with the roller 31 either counter- or co-rotated and then bringing the roller 31 back in opposite direction 33 with rotation without lifting the roller 31.

FIG. 1D is an example of a camera system 48 which may be incorporated as part of the material development tool 100 or provided as a separate component of the material development tool 100. As shown, a camera 40 responsive to visible light is controlled by a processor, CPU 42, to examine the surface of the indentation opening 12 to determine how well the build material 24 has been spread within the indentation 14. To help provide a better contrast between the surface of the first plate 10 and the build material 24, a low angle illumination source 50 may be used to provide light from a shallow or low angle 54 from the surface of first plate 10, such as between 5 and 45 degrees in some example systems or any angle below 30 degrees in other examples. By having a low angle illumination source 50, the projected light that strikes the top surface of the first plate 10 is reflected away from the camera 40, while the build material disposed in the indentation 14 scatters at least some of the reflected light to the camera 40.

The CPU 42 is coupled to a computer readable medium (CRM) 44 that contains software routine(s) of instructions to control camera 14 and determine the results of the spreading operation such as with a density measure routine 46 that resides in the CRM 44. The density measure routine 46 may evaluate the overall density of the build material within the indentation 14 relative to the amount of first plate 10 top surface viewable in the indentation 14. In some examples, the density measurement may be done in multiple segments of the area 17 of indention 14.

FIG. 1E is an example virtual density grid of an indentation that has been spread with a proposed build material 24. In this example, the area 17 of indentation 14 is broken up into a 5×5 grid of sub-sections 62 and the density of each sub-section 62 is measured and determined by camera 40 and density measure routine 46 and reported or displayed for each grid as a density value 64. Further, the density measure routine 46 may do further statistical analysis of the sub-section 62 results to arrive at an average, median, and standard deviation for the overall spread. Based on empirical testing, a proposed build material 24 may have to meet various thresholds for the average, median, and standard deviations before being assigned a passing score depending on suitability for a particular 3D printer or 3D process. For instance, if the standard deviation derived from the grid sub-sections 62 is greater than a threshold, there may be too much variance or non-uniformity of the spreading. Also, if a particular grid sub-section 62 density is determined to be below an acceptance threshold, then there may be a gap or hole in the spreading despite uniformity elsewhere and the spread test might be deemed a failure.

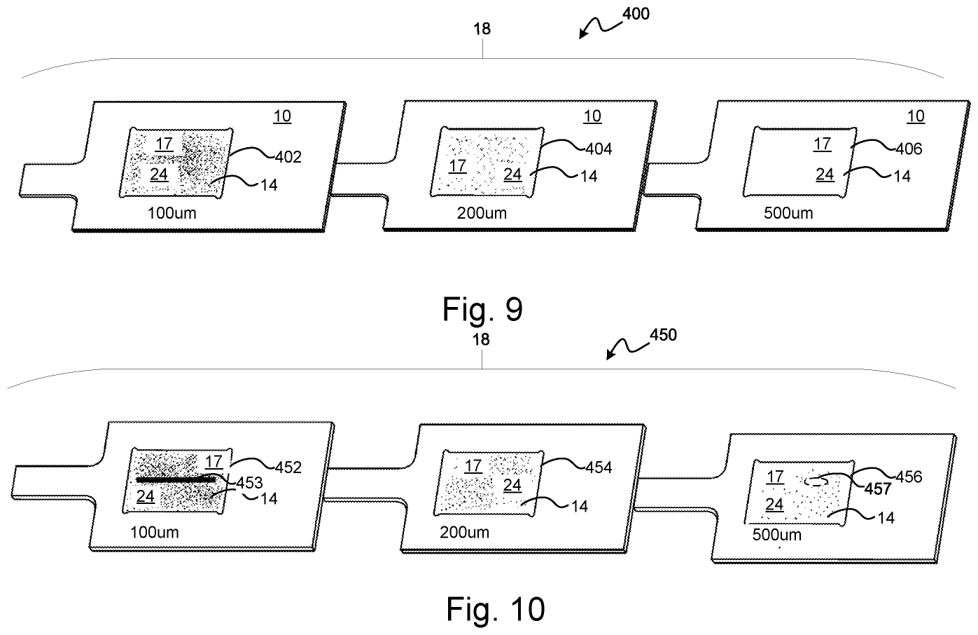

Furthermore, in some examples, the surfaces of indentation 14 may be polished smooth to make the spreading of a proposed build material 24 more difficult and thus separate out the spreadability of proposed different build materials 24. In fact, in other examples, the surfaces of indentation 14 may be coated with a non-stick surface, such as Teflon™ (PTFE or polytetrafluoroethylene), an electroless nickel-Teflon™, or other known non-stick surfaces such as such as anodized aluminum, ceramics, trans-ceramics, and silicone to name a few. In some examples, the first plate 10 may include a set 18 (see FIGS. 9 and 10) of first plates 12 each having similar areas 17 but having different depths 15 to test the spreadability of the proposed build material 24 at various depths. Being able to spread material at a shallow depth allows for finer resolution of the final product produced by a 3D printer, but at a cost of increased production time due to having more layers. Spreading material at a larger depth allows for speeding up the production time by having less layers to deposit but at a cost of lower or coarser resolution. By being able to have the material spreadable at multiple depths, a 3D printer's machine readable instructions may vary the depth of each layer used to produce an article based on the immediate resolution and thus both time and resolution goals can be achieved depending on the actual article shape and dimensions in its model file.

In another example, such as shown in FIG. 2, the first plate 10 may have an indentation 14 that has varying depth such as a stair step 70 with two or more (d1, d2, and d3 in this example) stair step depths 15 of various heights to determine the spreadability of the build material at various predetermined depths within the indentation 14 of a single first plate 10. This example may be of interest when the amount of a proposed build material is scarce or testing of multiple proposed build materials 24 is to be sped up. In some examples, a ramp incline or slope may be used instead of a stair step to have varying depth. Also, in some examples, the first plate 10 may include a tab 76 or other appendage to allow for the ease of holding, removal, and transporting a first plate 10 such as for replacing the first plate 10 with other first plates 10 or removing the first plate 10 from the material development tool 100 for inspection. Further, any indentations 14 with different depths 15, such as stair step 70, may be separate and spread along the first plate 10 area 17 rather than combined within a single indentation 14 as shown.

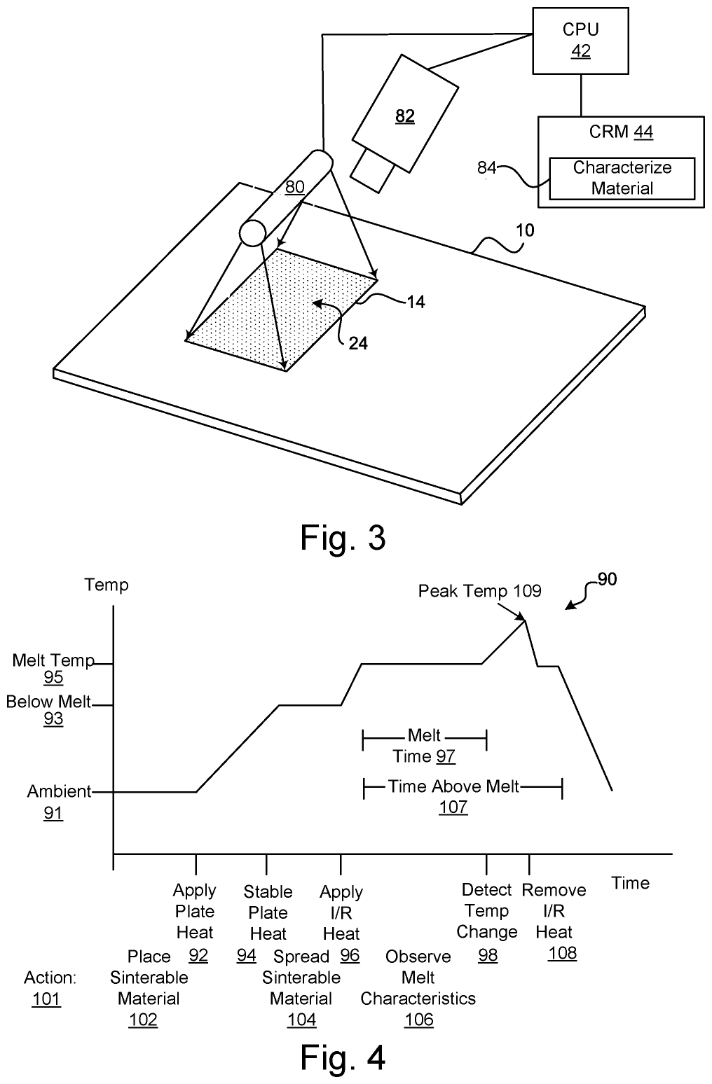

In addition to determining the spreadability of any proposed build material 24, it is also useful to determine how a proposed build material 24 performs as if it were used in a production 3D printer. Accordingly, in FIG. 3, the material development tool 100 may include an I/R camera 82 to monitor temperature, and an irradiation light source such as Infra-Red (I/R) light source 80 used to irradiate and increase the temperature of the build material 24 to its melting point and beyond to characterize its thermodynamic properties under similar conditions to a production 3D printer. The I/R camera 82 and light source 80 are coupled to a processor, CPU 42, which is further coupled to a non-transitory computer readable medium 44 having instructions in a characterization module 84 to control the light source 80 and read the I/R camera 82 to observe the characteristics of the build material 24. While this example illustrates an I/R light source, depending on the types of build material used, other light sources such as ultraviolet, laser, or far-infrared may be used. Multiple tests or characterizations may be done where the total time above melt (FIG. 4, 107) is modified to be able to observe how the material responds to heating and cooling after an irradiation source is removed.

While some 3D printers use a dispersing or fusing agent to help in the absorption of I/R light, in one example, no fusing agent is used to allow for determining the actual melt time 97 (FIG. 4) of the proposed build material 24. For instance, if a melt time is quite long, then an appropriate fusing agent may be determined to be used with the proposed build material 24 to allow the melt time of the combined two to meet the production 3D printer specifications. As different production 3D printers have different fusing light sources and operate at different speeds, testing with a particular fusing agent may not allow for determining if the proposed build material is usable, suitable, or compatible in various production 3D printers. However, in some examples, the material development tool 100 may also include a fusing agent supply and fusing agent delivery system to allow for testing how a proposed build material operates with the chosen fusing agent to verify suitability with a particular 3D printer or 3D printing process. For instance, some 3D printing systems may use multiple fusing agents, such as a “black”, a “low-tint”, or other color fusing agents.

FIG. 4 is a graph of an example operation of a set of actions 101 for a material development tool 100 using a chart 90 showing time on the horizontal or X axis and temperature of the build material 24 on the vertical or Y axis. When a first action of “place build material” 102 is performed, in this example, the action is done at ambient 91 temperature. After the material is placed in the opening 22 of second plate 20 and second plate 20 removed, an action of “apply plate heat” 92 is performed. This caused the first plate 10 and the build material 24 to rise in temperature to a temperature below melt 93 of the build material 24. Once the below melt temperature 93 is stable, an action of “spread build material” 104 is performed. A proposed build material 24 may have a worse spreading performance at an elevated temperature than at ambient temperature 91. Once the build material 24 has been spread, an action of “apply I/R heat” 96 may be done to increase the temperature of the build material 24 to its melt temperature 95. Because the melt temperature 95 represents a phase change (like melting ice) within the build material 24, an I/R camera 82 or thermo-couple may be used to perform the action “observe melt characteristics” 106. That is, the temperature of the build material 24 is observed to detect the melt time 97 of the build material 24 as it is heated by the I/R light source 80. Once the temperature of the build material 24 begins to rise beyond the melt temperature 95 and the action “detect temp change” 98 noted, then the build material 24 is fully melted and changed to its reptation state Reptation involves the thermal motion of very long linear, entangled macromolecules in polymer melts or concentrated polymer solutions. Reptation suggests the movement of entangled polymer chains as being analogous to reptile snakes slithering through one another. Thus, the powered build material 24 as it heats and melts entangles its macromolecules like snakes slithering through one another to form or coalesce into a solid piece of sintered material 24 that may be removed and tested for strength, such as by pressing out a dog bone or other shape for testing the maximum tensile strength and percent elongation of the solid piece of sintered material 24.

Before removal, an action “remove I/R heat” 108 is performed to withdraw the irradiation at peak temperature 109, and the build material 24 is allowed to cool and go through a phase change again before further cooling back to ambient temperature. The “time above melt” 107 and peak temperature 109 may be detected and determined to further characterize the thermodynamic properties of the build material 24.

The computer readable medium 44 allows for storage of sets of data structures and instructions (e.g. software, firmware, logic) embodying or utilized by any of the methodologies or functions described herein. The instructions may also reside, completely or at least partially, with the static memory, the main memory, and/or within the CPU 42 during execution by a computing system. The main memory and the CPU 42 memory also constitute computer readable medium 44. The term “computer readable medium” 44 may include single medium or multiple media (centralized or distributed) that store the instructions or data structures. The computer readable medium 44 may be implemented to include, but not limited to, solid state, optical, and magnetic media whether volatile or non-volatile. Such examples include, semiconductor memory devices (e.g. Erasable Programmable Read-Only Memory (EPROM), Electrically Erasable Programmable Read-Only Memory (EEPROM), and flash memory devices), magnetic discs such as internal hard drives and removable disks, magneto-optical disks, and CD-ROM (Compact Disc Read-Only Memory) and DVD (Digital Versatile Disc) disks.

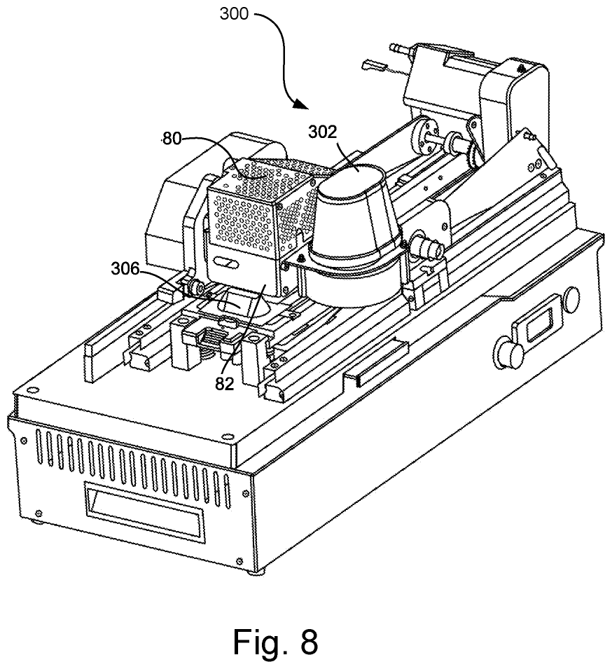

The various vison examples in FIG. 1D and FIG. 3 or heat plate 26 temperature control systems in FIGS. 7 and 8 and described herein may include logic or several components, modules, or constituents. Modules may constitute either software modules, such as code embedded in tangible non-transitory machine readable medium) or hardware modules. A hardware module is a tangible unit capable of performing certain operations and by be configured or arranged in certain manners. In one example, a computer system or a hardware module of a computer system may be configured by machine readable instructions (e.g. an application, or portion of an application) as a hardware module that operates to perform certain operations as described herein.

In some examples, a hardware module may be implemented as electronically programmable circuitry. For instance, a hardware module may include dedicated circuitry or logic that is permanently configured (e.g. as a special-purpose processor, state machine, a field programmable gate array (FPGA) or an application specific integrated circuit (ASIC) to perform certain operations. A hardware module may also include programmable logic or circuitry (e.g. as encompassed within a general-purpose processor or other programmable processor) that is temporarily configured by machine readable instructions to perform certain operations. It will be appreciated that the decision to implement a hardware module electronically in dedicated and permanently configured circuitry, or in temporarily configure circuitry (e.g. configured by machine readable instructions) may be driven by cost and time considerations.

In some situations, it may also be desirable to test how a proposed build material 24 performs in multiple layers. FIG. 5 is a perspective drawing illustrating the use of an additional third plate 72 that may be placed on top of the first plate 10 that includes a sintered or non-sintered first layer 24A of build material 24 in the indentation 14. The third plate 72 has an opening 71 the same length and width as indentation 14 of a depth 15 which is the same as the thickness of the third plate 72. A second plate 20 may be used to place an amount of build material 24B for a second layer to be spread in opening 71 over the first layer 24A using the recoater 30. The third plate 72 may be used multiple times to create a sample of sintered build material 24 to test its multilayer strength and other properties.

FIG. 6 is a perspective drawing of another example accessory C-shaped adapter 74 with ramps up and down for the material development tool 100. The additional adapter 74 may be used to ramp with first ramp 73 a roller 31 of recoater 30 before the build material 24 is spread to allow the roller 31 to approach the build material 24 at an angle that reduces the amount of build material 24 sticking to the roller 31. That is, the first ramp 73 may reduce the amount of mechanical pinching action between the roller 31 and the top surface of the first plate 10. Some materials may be more susceptible to agglomeration with the increased shear created by the roller 31 to first plate 10 pinch point. A second ramp 75 transitions the roller 31 to push and spread the proposed build material 24 into the indentation 14 as the roller 31 moves along the direction 32. This approach helps to prevent build material 24 from being pinched between the roller 31 and the first plate 12. Accordingly, the first ramp 73 elevates the roller 31 high enough to prevent any pinching, while allowing the build material 24 to spread into the indentation 14.

FIG. 7 is a perspective drawing of one example material development tool 200 implementing many of the discussed features. The first plate 10 is placed on top of a heat plate 26 disposed in an opening of a base 210 that is mounted above a waste hopper 220 that moves any excess build material when scrapped from the second plate 20 into a waste removal fixture 222. Once the build material has been placed on the first plate 10, the roller 31 of recoater 30 is advanced using a roller advancement motor 202 to move a pinion 204 along a rack 206 in a direction 32. For stability, the roller 31 is supported by recoater guides 232. A roller motor 230 is used to rotate the roller at a programmed speed by roller speed control 214. The heat plate 26 temperature may be manually adjusted by a temperature control 218 and the temperature of the heat plate read by a heat plate temperature monitor 216. In other examples the heat plate temperature 26 may be adjusted automatically by a processor 42 to control the temperature of the build material 24. Accordingly, the heat plate 26 temperature may be adjusted manually by a user or automatically in some examples. The various components of the material development tool 200 are mounted on a tool base 212 which may contain cooling vents 240 to allow any excess heat from the heat plate 26 and internal electronics to escape into the ambient air. The first plate 10 may be removed from the material development tool 200 by pressing on a first plate release lever 208 to expose tab 76 of first plate 10 (see FIG. 2 for example).

FIG. 8 is a perspective drawing of another example material development tool 300 like material development tool 200 of FIG. 7 but with the addition of an I/R light source 80, a fan 302, and an I/R camera 82. The I/R light source 80 directs its light energy to the indentation 14 of first plate 10 using a reflector 306 to irradiate the build material 24 and/or the recoater 30. The fan 302 may be used to cool the I/R light source 80 in some examples and in other examples, conductive cooling may be used and fan 302 not present or used.

FIGS. 9 and 10 are example results of spreading 400 and 450, respectively, for different proposed build material 24 into the area 17 of indentation 14 with a set 18 of first plates 10 each having a different depth 15 of the indentation 14. Within an area 17, black portions denote the plate surface of indentation 14 and white portions denote the build material. For instance, plate 402 in FIG. 9 and plate 452 in FIG. 10 each have a depth of 100 um (micrometers). Plate 404 in FIG. 9 and plate 454 in FIG. 10 each have a depth 15 of 200 um. Plate 406 in FIG. 9 and plate 456 in FIG. 10 each have a depth 15 of 500 um. FIG. 9 is an example spreading of a proposed build material 24 that has good uniform spreadability, although the density of plate 402 having 100 um of depth is less uniform (more black or plate surface showing) than either the spreading within the indentation 14 of plate 404 or plate 406 which have larger depths. FIG. 10 is an example of a proposed build material 24 having very poor spreading capability. As can be observed, the spreading of the material in plates 452, 454, and 456 are less non-uniform than the spreading in plates 402, 404, and 406. For instance, in plate 452, a clump of material has left a streak 453 in the spread build material 24 as the clump is dragged along the indentation 14. Plate 454 has more of the plate surface (the black areas) showing than Plate 404 of the same thickness. In other situations, clumps 457 of build material 24 may cling to the roller 31 and be deposited into the indentation 14 such as in plate 456.

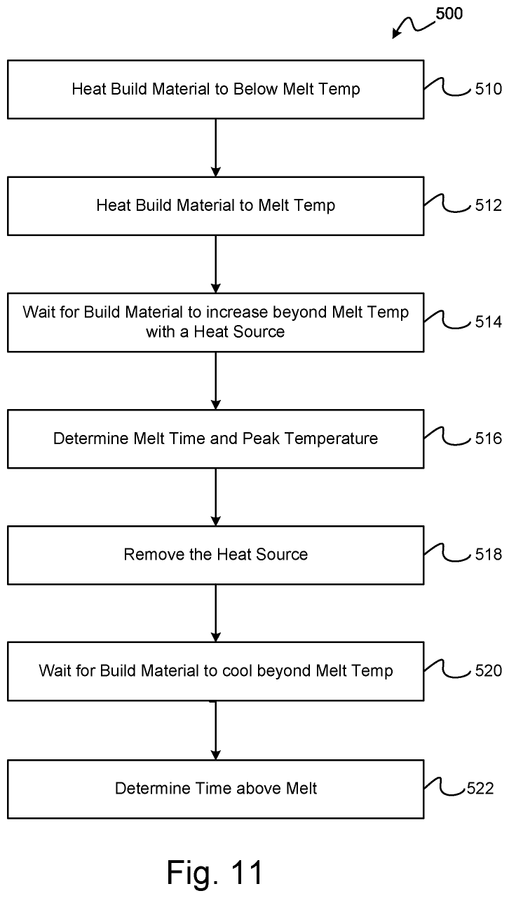

FIG. 11 is a flowchart 500 of an example set of instructions to characterize a build material 24. In block 510, the build material 24 is heated to below the melt temp 93 (FIG. 4). In one example this heating is done with a heat plate 26 and in another example, it is done with an irradiation light source 80 and in other examples heating is done with both a heat plate 26 and a light source 80. In block 512, the build material 24 is then heated to the melt temp 95. In some examples, a user may specify how long to hold the build material 24 at the melt temp 95 to explore the reptation property limits of build material 24 and in other examples, a processor may control the time the build material 24 is heated. For example, in block 514 the instructions cause the processor to wait until the build material 24 to increase beyond the melt temperature 95 as it goes through its phase change. In block 516 the melt time is determined from when the melt temp 95 is first reached and the time the melt temp 95 is exceeded. In block 518, the heat source, either the heat plate 26 or the irradiation light source 80 is removed and the build material 24 allowed to cool. The build material 24 will first cool to the melt temp 95 and the temperature stabilize as it transitions to a solid again. In block 520, the build material 24 is monitored until it begins to cool beyond or below the melt point 95. In block 522 the time above melt is determined by the difference from the time the build material 24 reaches the melt temp 95 and the time the build material 24 begins to cool beyond the melt temp 95.

In summary, a material development tool 100 has been disclosed for testing a 3D powder-based build material 24 to determine its suitability for use in a given 3D printer. The material development tool 100 may include a first plate 10 (or set 18 of interchangeable plates having different depths 15 of indentation), which may be heated, having an indentation 14 of a depth 15 equivalent to a powder layer thickness used in a production 3D printer. The material development tool 100 has a second plate 20 with an opening 22 to store a small quantity of proposed build material 24, and a recoater 30 to form a layer of the powder on the first plate 10 in the indentation 14. A camera 40 may be used to assess the spread characteristics of the build material 24, and a processor, CPU 42, may give an indication of the compatibility of the build material 24 with any desired production 3D printers.

In a simple implementation, a material development tool 100 includes a first plate 10 having an indentation 14 of a predetermined depth 15. A second plate 20 having an opening 22 for receiving a build material 24 when second plate 20 is placed on the first plate 10 and second plate 20 is removable from the first plate 10 to leave a precisely measured build material 24 on first plate 10. A recoater 30 is used to move and spread the build material 24 within the indentation 14 of the first plate 10. The material development tool 100 may include a non-stick coating (not shown) within the indentation 14 of first plate 10. The material development tool 100 may include a camera system 40 where the first plate 10 is to be examined with the camera system 40 to determine a density of the build material across an area 17 of the indentation 14. The material development tool 100 may determine the density using a low angle of illumination 54 to differentiate a surface of the indentation 14 and the build material 24. The material development tool 100 may have the area 17 of the indentation 14 divided into a virtual grid 60 of sub-sections 62 and the density of the build material 24 may be determined from a statistical analysis using each sub-section 62 of the virtual grid 60. The material development tool 100 may include a base 210 having an opening 211 and a heater 26 mounted inside the opening 211 and under the first plate 10 when disposed in the opening 211. The indentation 14 and the build material 24 are brought to a temperature 93 just before the melt temperature 95 of the build material 24 before the recoater 30 is moved to spread the build material 24 in the indentation 14.

The material development tool 100 may include a third plate 72 mountable on the first plate 10, the third plate 72 may have an opening 71 substantially the same as the indentation 14 to allow the recoater 30 to move and spread additional build material 24B on the build material 24A in the indentation 14. The material development tool 100 may include a light source 80 either stationary or designed to move across the indentation 14 irradiate and raise a temperature of the build material 24 above the melt temperature 95. An I/R camera 42 may be used to monitor the temperature of the build material 24 and determine a melt time 97 for the build material 24 to fully melt, a peak temperature 109, and a time above melt 107 for the build material 24 to fully melt and cool back to a solid form.

The material development tool 100 may include an adapter 74 to allow the recoater 30 to approach the build material 24 at an angle before spreading the build material 24 to reduce build material 24 from sticking to the recoater 30. In some examples, the material development tool 100 may include a first plate 10 where the indentation 14 is a stair step 70 of varying depths or the indentation has several separate indentations of varying depths.

In one particular example, a material development tool 300 includes a base 210 having an opening 211 with a heater 26 mounted inside the opening 211. A recoater 30 is used to move and spread an amount of build material 24 within an indentation 14 of a first plate 10 disposed on the heater 26 wherein the heater 26 raises a temperature of the build material 24 to just below a melt temperature 93 of the build material 24. A light source 80 is used either stationary or to move across the indentation 14 irradiate and raise the temperature of the build material 24 above the melt temperature. An I/R camera 82 is used to monitor the temperature of the build material 24 and determine a melt time 97 for the build material 24 to fully melt, a peak temperature 109, and a time above melt 107. In one example, the material development tool 200 further includes a camera system 48 to determine a density of the build material 24 across an area 17 of the indentation 14.

In another example, a material development tool 200 includes a base 210 having an opening 211 and a first plate 10 having an indentation 14 of a predetermined length 13, width 11, and depth 15. The first plate 10 is to be disposed and removable within the opening 211. A second plate 20 having an opening 22 for receiving build material 24 when it is placed on the first plate 10. The second plate 20 is to be removable from the first plate 10. The second plate 20 has a width 21 about the same as the width 11 of the indentation 14 and an opening 22 having a volume 29 at least as large as a volume 19 of the indentation 14. A recoater 30 is used to move and spread the build material 24 within the indentation 14 of the first plate 10. A camera system 48 is used to determine a density of the build material 24 across an area 17 of the indentation 14 of the first plate 10. The material development tool 200 may determine the density using a low angle 54 of illumination 50 to differentiate a surface of the indentation 14 and the build material 24. In one example, the area of the indentation 14 is divided into a virtual grid 60 of sub-sections 62 and the density of the build material 24 is determined from a statistical analysis using each sub-section 62 of the virtual grid 60.

While the claimed subject matter has been particularly shown and described with reference to the foregoing examples, those skilled in the art will understand that many variations may be made therein without departing from the intended scope of subject matter in the following claims. This description should be understood to include all novel and non-obvious combinations of elements described herein, and claims may be presented in this or a later application to any novel and non-obvious combination of these elements. The foregoing examples are illustrative, and no single feature or element is to be used in all possible combinations that may be claimed in this or a later application. Where the claims recite “a” or “a first” element of the equivalent thereof, such claims should be understood to include incorporation of one or several such elements, neither requiring nor excluding two or more such elements.

What is claimed is:

1. A material development tool, comprising:
a first plate having an indentation of a predetermined depth;
a second plate having an opening for receiving build material when placed on the first plate and removable from the first plate; and
a recoater to move and spread the build material within the indentation of the first plate.

2. The material development tool of claim 1, wherein the first plate has a non-stick coating within the indentation.

3. The material development tool of claim 1, further comprising a camera system having a processor and wherein the first plate is to be examined with the processor of the camera system to determine a density of the build material across an area of the indentation.

4. The material development tool of claim 3 wherein the density is determined using a low angle of illumination to differentiate a surface of the indentation and the build material.

5. The material development tool of claim 3 wherein the area of the indentation is divided into a virtual grid of sub-sections and the density of the build material is determined from a statistical analysis using each sub-section of the virtual grid.

6. The material development tool of claim 1 further comprising:
a base having an opening;
a heater mounted inside the opening and under the first plate when disposed in the opening and wherein the indentation and the build material are brought to a temperature just before the melt temperature of the build material before the recoater is moved to spread the build material in the indentation.

7. The material development tool of claim 1 further comprising a third plate mountable on the first plate, the third plate having an opening substantially the same as the indentation to allow the recoater to move and spread additional build material on the build material in the indentation.

8. The material development tool of claim 1 further comprising
a light source irradiating the indentation and raise a temperature of the build material above a melt temperature;
a processor, and
an I/R camera coupled to the processor to monitor the temperature of the build material and determine a characteristic for the build material.

9. The material development tool of claim 1 further comprising an adapter to allow the recoater to approach the build material at an angle before spreading the build material to reduce build material from sticking to the recoater.

10. The material development tool of claim 1 wherein the indentation has a varying depth.

11. A material development tool, comprising:
a base having an opening; and
a processor coupled to:
a heater mounted inside the opening;
a recoater to move and spread an amount of build material within an indentation of a first plate disposed on the heater wherein the processor controls the heater to raise a temperature of the build material to just below a melt temperature of the build material;
a light source coupled to the processor to irradiate the indentation and the processor controls the light source to raise the temperature of the build material above the melt temperature; and
an I/R camera coupled to the processor to monitor the temperature of the build material and determine a time for the build material to fully melt.

12. The material development tool of claim 11 further comprising a camera system coupled to the processor to determine a density of the build material across an area of the indentation.

13. The material development tool of claim 12 wherein the density is determined using a low angle of illumination to differentiate a surface of the indentation and the build material.

14. A non-transitory computer readable medium comprising instructions that when read by a processor cause the processor to:
heat build material below a melt temperature;
heat build material to a temperature to the melt temperature with a heat source;
wait for the build material to increase beyond the melt temperature;
determine a melt time from the time when the build material reaches the melt temperature to a time when the build material increases beyond the melt temperature;
remove the heat source;
wait for the build material to cool beyond the melt temperature; and
determine a time above melt from the time the build material increases reaches the melt temperature to the time when the build material cools beyond the melt temperature.

15. The non-transitory computer readable medium further comprising instruction to allow a user to specify the amount of time the build material is to remain above the melt temperature to a peak temperature.
